(19) United States
(12) Patent Application Publication
(10) Pub. No.: US 2024/0429775 A1
(43) Pub. Date: Dec. 26, 2024

(54) Flow Element and Electric Machine With a Flow Element

(71) Applicant: Bayerische Motoren Werke Aktiengesellschaft, Muenchen (DE)

(72) Inventors: Benjamin KRANK, Muenchen (DE); Bernhard WOLF, Muenchen (DE)

(21) Appl. No.: 18/698,442

(22) PCT Filed: Dec. 5, 2022
(86) PCT No.: PCT/EP2022/084404

§ 371 Date: Apr. 4, 2024

(30) Foreign Application Priority Data
Dec. 20, 2021 (DE) 10 2021 133 860.3

(51) Int. Cl. H02K 5/20; H02K 3/24

(52) U.S. Cl. CPC H02K 5/20; H02K 3/24

(57) ABSTRACT

A flow element and an electric machine are provided. The electric machine includes a rotor arranged on a rotor shaft, a stator and a flow element, which is designed to direct a fluid output from the rotor shaft into an interior of the electric machine to an end side of the rotor.

### BACKGROUND AND SUMMARY

The invention relates to an electric machine having a rotor which is arranged on a rotor shaft, a stator and a flow element which is configured to direct a fluid, which is discharged from the rotor shaft into an inner space of the electric machine, to a front side of the rotor.

Electric machines can be used as operating machines for electrically drivable motor vehicles, for example, electric vehicles and hybrid vehicles. In this instance, electric machines can be used with a wide variety of embodiments, wherein an electric machine typically has a stator which is supported in a manner fixed in position and a rotor which is supported in a movable manner relative to the stator. In current-excited electric machines, active components have systems which generate magnetic fields, for example, in the form of windings which can be supplied with electric current and which are retained by an iron core in order to generate a magnetic flux. Such windings may become heated during operation of the electric machine, whereby, for example, as a result of non-homogeneous temperature distribution in the winding, local hot spots can be produced. Since heating of the electric machine can negatively influence efficiency and permanent power, solutions for cooling the electric machine are known. For example, a cooling covering can be arranged around the stator in order to cool the stator and a cooling medium flows through it, or the rotor may have a shaft which is in the form of a hollow shaft and through which a cooling medium flows.

An object of the present invention is to improve cooling and/or lubrication of an electric machine.

This object is achieved by an electric machine and a flow element according to the independent claims. Advantageous embodiments are set out in the dependent patent claims, the description and the Figures.

According to a first aspect, an electric machine having a rotor which is arranged on a rotor shaft, a stator and a flow element is proposed, wherein the flow element is configured to direct a fluid, which is discharged from the rotor shaft into an inner space of the electric machine, to a front side of the rotor.

The electric machine may be used, for example, as an electric traction machine for an electrically operable motor vehicle. The electric machine is particularly in the form of a current-excited synchronous machine (SSM) or an asynchronous machine (ASM). The electric machine may have a stator which is supported in a manner fixed in position and a rotor which is supported in a movable, in particular rotatable, manner with respect to the stator. In this case, the rotor has a rotor iron which may be formed, for example, by a rotor plate assembly comprising axially stacked sheet metal plates. Furthermore, the rotor may have an electrically conductive winding which is configured for generating or exciting a magnetic flux for guiding current. In a current-excited synchronous machine, for example, the winding may be in the form of an exciter coil which can be supplied with electric current. The exciter coil may comprise, for example, rod-like conductors or shaped rods which are arranged in grooves of the rotor iron or on the circumferential surface thereof. The coil may comprise winding wires which are wound around poles of the rotor iron.

In order to cool the electric machine, the rotor shaft is configured to be flowed through by fluid and may, for example, be in the form of a rotating hollow shaft through which a fluid or cooling medium flows and about which the rotor is arranged in a rotationally secure manner. The fluid is particularly an electrically non-conductive cooling medium, for example, oil. It can be taken from a coolant circuit or a lubricant circuit, in particular in order not to impair an ability of the electric machine to operate during direct contact with current-carrying components.

The rotor shaft may have an outlet or an outlet opening for discharging coolant from the hollow rotor shaft, in particular into an inner space which is formed between the rotor and stator. During a rotational movement of the rotor, the fluid can be transported radially outward from the rotor shaft or in the inner space particularly by centrifugal force in order to wet machine components and consequently to allow a transmission of heat.

The inner space of the electric machine is delimited by a housing. Consequently, the fluid or coolant can be located in the inner space of the electric machine and a wet electric machine, in particular a wet electric motor, may be spoken of. In particular, the rotor and the stator are arranged in the inner space and the fluid can interact, in the inner space of the electric machine, directly with the components of the electric machine to be cooled.

The flow element is arranged in the inner space and can be arranged and/or secured on the rotor, on the stator and/or on the rotor shaft. As a result of such an arrangement of the flow element on a component, for example, the rotor shaft, a thermal transmission between the flow element and the respective component of the electric machine can be carried out. In particular, the flow element has aluminum or is made from aluminum in order to allow a thermal transmission between the fluid and flow element in the region of the flow element, particularly if the flow element is connected to the rotor or another component of the electric machine in a thermally conductive manner.

By means of the flow element, the fluid or coolant discharged from the rotor shaft can be directed to a front side of the rotor and/or to predetermined components or guided past it/them, wherein in particular a suction effect which is caused by centrifugal force during a rotational movement of the rotor can ensure that the fluid is always transferred. As a result of the thermal connection provided in this manner between the fluid and the front side of the rotor and/or components to be cooled, heat which is generated during operation can be discharged and removed from the system. A front side of the rotor can be an axial end of the rotor, at which in particular winding heads of rotor windings which may form hot spots during operation of the rotor can be arranged. In particular, the rotor has two mutually oppositely arranged front sides, wherein in one embodiment of the invention a flow element can be associated with each of the two front sides.

In that the flow element is configured to direct the fluid to a front side of the rotor, heat which is produced in the rotor can be taken up by the fluid and transported away. It is thereby possible to improve capacity of the rotor for cooling and consequently to adjust a homogenized temperature level. The fluid may, for example, be transported or directed through the rotor or at least along a front side of the rotor. In this case, the fluid can flow radially past the front side and particularly also be conveyed through and between individual rotor plates and/or through a rotor winding. In this case, the coolant can be guided directly to or very near the locations which are intended to be cooled. Thus, in particular a coolant flow, which can ensure a thermal discharge, through the rotor can be produced.

By arranging or configuring the flow element, particularly a mass flow of the fluid which is or is intended to be directed by the flow element can be predetermined. Consequently, a temperature distribution in the electric machine can be homogenized and/or local hot spots can be avoided. It is thereby possible, for example, to increase efficiency and/or permanent power of the electric machine. Furthermore, the selective guiding of the fluid to predetermined components, which are intended to be cooled, of the rotor can in this case reduce the pressure on a coolant pump which is arranged outside the electric machine so that it can have smaller dimensions and be more lightweight.

In one embodiment, the flow element can, together with the rotor front side, form a gap in which the fluid is or is intended to be guided in order to improve a cooling action of the fluid at the rotor. At a radial outer side, the fluid can be discharged from the gap and can be directed by means of the flow element to another component of the electric machine, for instance, to the stator.

In one embodiment, the flow element is configured to direct the fluid to at least one stator winding. Consequently, the stator and in particular winding heads of the stator can also be cooled. As a result of a flow direction, which is brought about by means of the flow element, of the fluid, coolant can be applied directly to the stator, whereby the heat thereof can be discharged. Consequently, a low temperature level in the stator, particularly in the stator winding heads, can be produced.

In another embodiment, the flow element can be configured to direct the fluid for cooling and/or lubricating a bearing, in particular of the rotor. Consequently, the fluid can be used for a plurality of functions, which may result in a cost-effective construction of the electric machine and a degree of efficiency of the electric machine can be improved because an additional lubrication system can be relieved of pressure or even dispensed with.

In one embodiment, the flow element is arranged in a fluid flow which is discharged from the rotor shaft or which is associated with a fluid discharge device and/or a fluid outlet of the rotor shaft. There is thereby produced particularly a spatial proximity between the flow element and the discharged fluid flow so that at least some of the fluid being discharged can be used for directing by means of or at the flow element, particularly before it becomes distributed by the active centrifugal forces in the inner space of the electric machine. It is thereby possible to direct a fluid flow, in particular a predetermined portion of the mass flow of fluid, by means of the flow element to the component which is intended to be cooled. Consequently, a selective direction of at least some of the discharged fluid flow is enabled in order consequently to allow a selective cooling of the electric machine.

In one embodiment, the flow element is in the form of an annular disk. Such an annular disk is particularly arranged around the rotor shaft and with spacing therefrom. To this end, the annular disk has an internal diameter which is in particular greater than a diameter of the rotor shaft and an external diameter which particularly corresponds substantially to a diameter of the rotor which is associated with the annular disk. As a result of the configuration in the manner of an annular disk, the flow element can be arranged radially outside a rotor bearing seat in order to allow a space-saving arrangement and thus to maintain an axial dimension of the electric machine. Alternatively, an internal diameter of the annular disk may be configured to be smaller up to an external diameter of the rotor shaft, whereby a maximum surface of the flow element can be provided for directing fluid in order to allow increased cooling performance.

The annular disk is particularly arranged or secured at the front side of the rotor in order consequently to promote guiding of fluid to the rotor or a front side or in a gap which is formed between the annular disk and the front side. Furthermore, such an annular disk or an annular disk which is arranged in this manner can rotate with the rotor, which allows improved guiding of the fluid as a result of the centrifugal forces which are brought about by means of the rotor rotation. Consequently, a uniform distribution of fluid to components and/or in the inner space of the electric machine can be brought about. In one embodiment, such a flow element can be arranged at both front sides of the rotor. As a result, a uniform cooling of the electric machine can be carried out.

The flow element has a collection structure which is configured to collect fluid which is discharged from the rotor shaft, in particular coolant, and can be configured to direct a fluid, in particular coolant, which is discharged from the rotor shaft into an inner space of the electric machine to a front side of the rotor. To this end, for example, the flow element may have a structure which faces the rotor shaft or an outlet of the rotor shaft, in particular in the form of a bevel or lip, which is configured to collect fluid which is being discharged in a radial direction. This collected or caught fluid can then be directed at the flow element or by the flow element or can flow along it in order to be directed to a component of the electric machine. Furthermore, the trajectory of the fluid flow can be changed to a predetermined direction by means of the collection structure in order to be directed to a target region, in particular to the front side of the rotor. By collecting the fluid by means of the collection structure, it is at least partially possible to avoid fluid flowing or travelling past a component which is intended to be cooled, whereby the degree of efficiency of the cooling can be increased.

In other words: the coolant can be directed out of a recess of the rotor shaft under the influence of centrifugal forces from the rotation of the rotor during operation into the inner space of the electric machine and can flow at that location via the collection structure, in particular a collection funnel, to or between the flow element which is configured, for example, in an annular manner in a location radially further outward. The flow element may be in the form of a simple attachment of the rotor front face which is intended to be cooled. The attachment then forms with the directly contacted rotor plate surface, for example, a component pairing which is configured axially outwardly to be flat in a manner optimized for friction.

In one embodiment, the flow element has at least one flow structure which is configured to disrupt a fluid flow, in particular a knob structure, which is arranged in a particularly predicted flow path. The flow element may have a large number of flow structures, wherein they may be arranged in an ordered and/or chaotic manner on the surface of the flow element. Such flow structures, which are formed on a surface of the flow element, for example, in a knob-like and/or rib-like manner, can be arranged on a surface which faces the component to be cooled of the electric machine, for example, the rotor front side. The surface enlargement, which is thereby caused, of the flow element can increase a heat transfer coefficient between the fluid and the component surface in order to improve a discharge of heat. Furthermore, turbulence can be generated in the fluid flow by means of a flow structure, whereby a thermal transmission to fluid-wetted surfaces can be improved.

In one embodiment, the flow element has at least one guide channel which is configured to direct a fluid flow to a rotor winding. A guide channel may, for example, be a groove-like recess in the flow element and/or can be formed by at least one, in particular two, rib-like bulges on the surface of the flow element. It is thereby possible to direct fluid to predetermined regions, in particular hot spots. Such hot spots can be located in a region of winding heads of the rotor or rotor windings. It is thereby possible to supply a greater quantity of fluid to these locations in order to obtain better cooling at that location.

In one embodiment, a guide channel can be configured, in particular together with the front side of the rotor and/or components which are arranged thereon, such as, for example, a support ring, to form a reservoir for the fluid in order to accumulate the fluid, particularly locally. It is thereby possible to retain the fluid for a longer time on the front side of the rotor in order to be able to improve a thermal transmission between the front side and the fluid. The flow element or a guide channel can have at least one discharge opening which is arranged in particular on a radial circumference of the flow element and which is configured to discharge fluid to the inner space of the electric machine or in the direction of at least one stator winding. In this case, a plurality of outlet openings can be formed with a predetermined spacing from each other, in order to be able to allow a selective discharge of fluid.

Such flow structures and/or guide channels can have round, angular or inclined configurations, formed contact connections and/or rib shapes. For example, flow elements and/or guide channels can be in the form of radial blade geometries in order to allow a selective fluid guiding or fluid movement.

In one embodiment, the flow element has at least one redirecting structure which is configured to direct a redirectable fluid flow to at least one stator winding. To this end, for example, a flow element which is in the form of a disk or annular disk can have at the radially outer edge thereof, in particular circumferentially, an oblique contour which is configured to impart a direction to a fluid flow. Consequently, a fluid flow which has been directed by means of the flow element can be discharged in a predetermined direction or at a predetermined angle to, for example, a stator winding head. Thus, a selective cooling of the stator or a stator winding can be carried out in order thus to allow a homogeneous temperature distribution in the electric machine.

In one embodiment, the flow element is configured to reduce a flow resistance at a surface which faces away from the rotor. To this end, in particular a side, which faces away from the side formed for fluid guiding, of the flow element may have a smooth surface in order to avoid or reduce a resistance which may be produced particularly by turbulence.

According to another aspect, the invention also includes a flow element which is configured to be arranged in an electric machine and to guide a fluid for the electric machine. In particular, the flow element is formed in a manner described herein, particularly as disclosed with respect to the embodiments and/or exemplary embodiments of the electric machine described herein. By means of such a flow element, a homogenized cooling of an electric machine can be enabled.

The embodiments and advantages described herein apply accordingly to a motor vehicle having such an electric machine.

Additional features of the invention will be appreciated from the claims, the Figures and the description of the Figures. The features and feature combinations mentioned above in the description and the features and feature combinations mentioned below in the description of the Figures and/or the features and feature combinations shown in the Figures alone can be used not only in the combination set out but also in other combinations or alone. Other advantages and possible applications of the invention will be appreciated from the following description in connection with the Figures. In the drawings:

### BRIEF DESCRIPTION OF THE DRAWINGS

FIG. 1 shows a schematic sectioned view of an exemplary embodiment of an electric machine according to the invention,

FIG. 2 shows a schematic illustration of an exemplary embodiment of a flow element according to the invention,

FIG. 3 shows a schematic illustration of an exemplary embodiment of another flow element according to the invention.

### DETAILED DESCRIPTION OF THE DRAWINGS

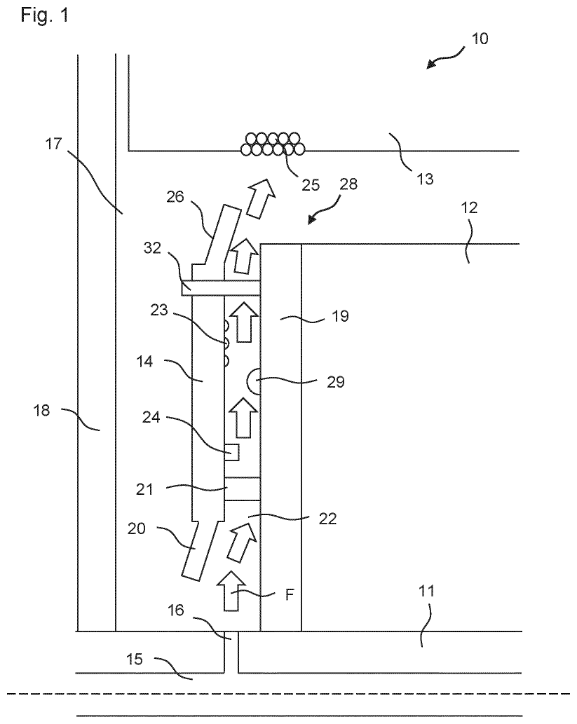

FIG. 1 shows a schematic sectioned view of a cut-out of an exemplary embodiment of an electric machine 10 according to the invention.

The electric machine 10 has a rotor 12 which is arranged on a rotor shaft 11, a stator 13 and a flow element 14. The rotor shaft 11 has a hollow space 15 through which fluid can flow and from which via an outlet 16 a fluid F or coolant (indicated by arrows) can be discharged from the rotor shaft 11 into an inner space 17 of the electric machine 10. The inner space 17 is delimited by a housing 18.

The flow element 14 which is in the form of an annular disk is arranged in a fluid flow F which is discharged from the rotor shaft 11 and is connected to a front side 28 of the rotor 12 via securing means 32. In the exemplary embodiment illustrated, the flow element 14 is secured to a support ring 19 which is arranged at the front side 28 of the rotor 12. Furthermore, a support structure 21 is provided on the flow element 14 which supports the flow element 14 against the front side 28 of the rotor 12 in order to support a dimensional stability of a gap 22 which is formed by the flow element 14 and front side 28. A front structure 32 which can support turbulence of the fluid F which is guided in the gap 22 is formed on the support ring 19.

The flow element 14 is configured to direct the fluid F which is discharged particularly by centrifugal forces which are produced during rotor movement and which flow through the inner space, to a front side 28 of the rotor 12. To this end, the flow element 14 has a collection structure 20 which is configured to collect fluid F which is discharged from the rotor shaft 11 in order to direct it to the front side 28 of the rotor 12. The collection structure 20 is in the form of an oblique structure at an internal circumference of the flow element 14 in order to collect at least some of the fluid flow F so that it can be guided selectively to a rotor component which is intended to be cooled and is not distributed in the inner space 17 of the electric machine 10 in an uncontrolled manner.

The flow element 14 has a flow structure 23 which is configured to disrupt the directed fluid flow F, in particular in order to improve a thermal transmission between the fluid F and surface of the flow element 14 and the front rotor side 28 or the support ring 19 by bringing about turbulence in the fluid F. The flow structure 23 is in the form of a knob structure and is arranged in a predicted flow path of the fluid F. Furthermore, the flow element 14 has a guide channel 24 which is configured to direct the fluid flow F to a rotor winding in order to be able to selectively cool it.

In order to be able to additionally use a cooling action of the fluid F for the electric machine 10, the flow element 14 is configured to direct the fluid F to the stator 13 or a stator winding 25 which is arranged at that location. To this end, the flow element 14 has a redirecting structure 26 in order to discharge the directed fluid flow F in the direction of the stator winding 25 and thereby to discharge heat which is produced thereby during operation. The redirecting structure 26 is in the form of an oblique contour at an external circumference of the annular-disk-like flow element 14 in order to discharge at least some of the fluid flow F in a directed manner so that it can be selectively guided to a rotor component which is intended to be cooled and is not distributed in an uncontrolled manner in the inner space 17 of the electric machine 10.

At the surface thereof opposite the flow channel formed by the gap 22, the flow element 14 is formed in an unstructured or smooth manner in order to reduce a flow resistance during a rotational movement of the rotor 12 against a medium which is contained in the inner space 17.

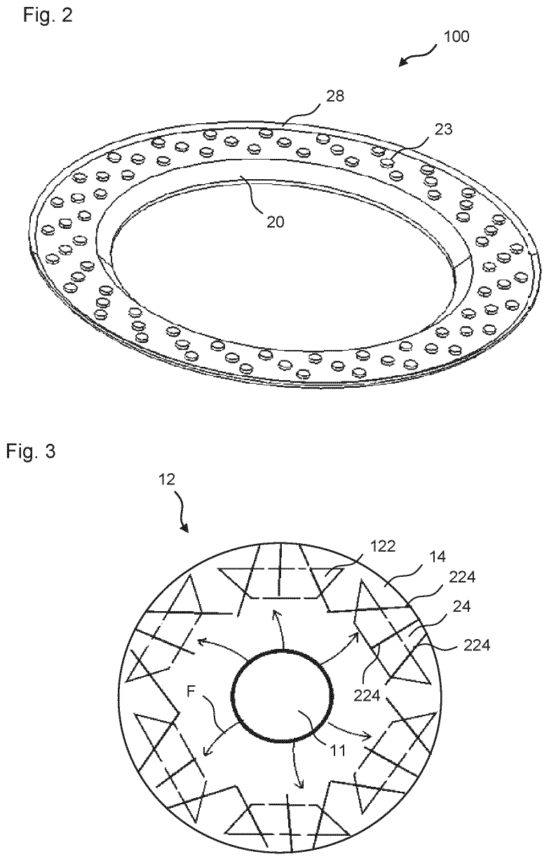

FIG. 2 shows a schematic illustration of an exemplary embodiment of a flow element 14 according to the invention for an electric machine 10.

The flow element 14 is in the form of an annular disk and has a collection structure 20 at the internal diameter thereof in order to collect fluid F which flows out of a rotor shaft 11 and to direct it to a component to be cooled, for example, a rotor 12. A knob structure 23 is formed at a surface of the flow element 14 in order to increase the surface of the flow element 14 and to disrupt a passing fluid flow F in order to improve a thermal transmission. At the external diameter thereof, the flow element 14 has a redirecting structure 26 in order to redirect an outgoing fluid flow F to at least one stator winding 25.

FIG. 3 shows a schematic illustration of an additional exemplary embodiment of a flow element 14 according to the invention which is arranged at the front side on a rotor 12 (not illustrated in greater detail).

The flow element 14 has guide channels 24 which are configured to direct a fluid flow F in a radial direction in order to be transported to a rotor winding 122 which is arranged on the rotor 12 and at that location to allow a thermal transmission from the rotor shaft 122 to the fluid F. The guide channels 24 are arranged on a surface of the flow element 14 and are formed by ribs 224, between which the fluid F can be directed in order to selectively be directed to a hot spot and consequently to act counter to overheating of components in the electric machine 10.

### LIST OF REFERENCE NUMERALS

10 Electric machine
11 Rotor shaft through which fluid can flow

### 12 Rotor

### 13 Stator

14 Flow element
15 Hollow space through which fluid can flow

### 16 Outlet

17 Inner space

### 18 Housing

19 Support ring
20 Collection structure
21 Support structure

### 22 Gap

23 Flow structure
24 Guide channel
25 Stator winding
26 Redirecting structure
28 Front side of rotor
29 Front structure
32 Securing means
122 Rotor winding

### 224 Rib

F Fluid

1.-9. (canceled)

10. An electric machine comprising:
a rotor which is arranged on a rotor shaft;
a stator; and
a flow element which includes a collection structure configured to collect a fluid discharged from the rotor shaft and to direct the fluid into an inner space of the electric machine to a front side of the rotor.

11. The electric machine according to claim 10, wherein the flow element is configured to direct the fluid to at least one stator winding of the stator.

12. The electric machine according to claim 10, wherein the flow element is arranged in a fluid flow which is discharged from the rotor shaft.

13. The electric machine according to claim 11, wherein the flow element is arranged in a fluid flow which is discharged from the rotor shaft.

14. The electric machine according to claim 10, wherein the flow element is in a form of an annular disk.

15. The electric machine according to claim 10, wherein the flow element has at least one flow structure which is configured to disrupt a fluid flow, and the at least one flow structure is a knob structure, which is arranged in a predicted flow path.

16. The electric machine according to claim 11, wherein the flow element has at least one flow structure which is configured to disrupt a fluid flow, and the at least one flow structure is a knob structure, which is arranged in a predicted flow path.

17. The electric machine according to claim 12, wherein the flow element has at least one flow structure which is configured to disrupt the fluid flow, and the at least one flow structure is a knob structure, which is arranged in a predicted flow path.

18. The electric machine according to claim 10, wherein the flow element has at least one guide channel which is configured to direct a fluid flow to a rotor winding.

19. The electric machine according to claim 11, wherein the flow element has at least one guide channel which is configured to direct a fluid flow to a rotor winding.

20. The electric machine according to claim 12, wherein the flow element has at least one guide channel which is configured to direct the fluid flow to a rotor winding.

21. The electric machine according to claim 10, wherein the flow element has at least one redirecting structure which is configured to direct a redirectable fluid flow to at least one stator winding.

22. The electric machine according to claim 11, wherein the flow element has at least one redirecting structure which is configured to direct a redirectable fluid flow to at least one stator winding.

23. The electric machine according to claim 10, wherein the flow element is configured to reduce a flow resistance at a surface which faces away from the rotor.

24. The electric machine according to claim 11, wherein the flow element is configured to reduce a flow resistance at a surface which faces away from the rotor.

25. The electric machine according to claim 12, wherein the flow element is configured to reduce a flow resistance at a surface which faces away from the rotor.

26. A flow element which is configured to be arranged in an electric machine and to guide a fluid for the electric machine.
